(19) United States
(12) Patent Application Publication
(10) Pub. No.: US 2026/0284627 A1
(43) Pub. Date: Sep. 24, 2026

(54) ANTI-COKING AND STABLY-OPERATING APPARATUS AND METHOD FOR CO-PRODUCING AVIATION FUEL AND CHEMICAL FEEDSTOCK FROM WASTE BIOMASS

(71) Applicant: SICHUAN UNIVERSITY, Chengdu (CN)

(72) Inventors: Xia JIANG, Chengdu (CN); Hualin WANG, Chengdu (CN); Jiehuizi WEN, Chengdu (CN); Jianping LI, Chengdu (CN); Yulong CHANG, Chengdu (CN)

(73) Assignee: SICHUAN UNIVERSITY, Chengdu (CN)

(21) Appl. No.: 19/531,699

(22) Filed: Feb. 6, 2026

(30) Foreign Application Priority Data
Mar. 18, 2025 (CN) 202510321813.9

(51) Int. Cl. B01J 8/24; C10G 3/00; C10L 1/02

(52) U.S. Cl. CPC B01J 8/24; C10G 3/45; C10G 3/50; C10L 1/026; C10G 2300/1014; C10G 2300/1022; C10G 2300/202; C10G 2300/4081

(57) ABSTRACT

An anti-coking and stably operating apparatus for co-producing aviation fuel and chemical feedstock from waste biomass is provided. The apparatus includes a low-energy consumption second-scale biomass drying-coupled pyrolysis and fractionation conversion to bio-crude unit, a bio-crude suspended bed hydrodeoxygenation and upgrading to low-oxygen bio-oil unit, and a low-oxygen bio-oil fixed-bed molecular reconstruction to hydrocarbon aviation fuel unit. By arranging a flash reaction thermal start-up mechanism capable of stepwise temperature rise for coking inhibition and online switching for decoking, the device rapidly crosses the coking reaction time point, transfers the coking position, and realizes spatiotemporal decoupling of coking risk and the long-term stable operation of the device for co-producing aviation fuel and chemical feedstock from waste biomass. The entire process adopts a coupled hydrogen and heat self-sustaining operation mode to achieve self-supply of drying heat and upgrading hydrogen, solving the problem of high external source costs.

### CROSS REFERENCE TO THE RELATED APPLICATIONS

This application is based upon and claims priority to Chinese Patent Application No. 202510321813.9, filed on Mar. 18, 2025, the entire contents of which are incorporated herein by reference.

### TECHNICAL FIELD

The present invention belongs to the technical field of resource carbon neutrality, relates to the emerging field of biomass zero-carbon fuels, and in particular relates to an anti-coking and stably operating apparatus and method for co-producing aviation fuel and chemical feedstock from waste biomass.

### BACKGROUND

As one of the key sectors for achieving the “dual carbon” goals in the transportation industry, the aviation industry has attracted increasing attention. Greenhouse gas emissions from the aviation transport sector account for approximately 13% of the total carbon dioxide emissions from all transport sources. Furthermore, by 2050, aviation emissions are projected to rise to around 1.8 billion metric tons of carbon dioxide per year, nearly doubling the 2019 level. Therefore, to meet the target of net-zero carbon emissions by 2050, a reduction of approximately 8.2 billion metric tons of carbon dioxide is required, which poses a significant challenge to the aviation transport industry. Compared with other industries, the aviation industry has relatively limited emission reduction solutions and pathways, making it difficult to reduce emissions, and it is regarded as one of the “hard-to-abate” sectors. However, sustainable aviation fuel (SAF) not only features high calorific value and zero emissions but also eliminates the need for large-scale modifications to existing infrastructure, aircraft engines, and operation management systems when used, thereby significantly reducing emission reduction costs. Consequently, it brings new possibilities and prospects for emission reduction in the aviation industry.

Currently, the main feedstocks for sustainable aviation fuel include waste cooking oil (commonly known as “gutter oil”), algae, and lipid materials. Nevertheless, these are still insufficient to meet the raw material demand for SAF production. Waste biomass, such as crop straw and wood chips, is not only a medium for storing solar energy but also adheres to the principle of “not competing with humans for food or land” and possesses zero-carbon properties. It is expected to serve as a supplementary feedstock to replace petroleum in SAF production, contributing to carbon emission reduction in the aviation sector. Therefore, there is an urgent need to produce biomass-based aviation fuel using waste biomass as the raw material to serve as a supplementary fuel.

However, the technology for producing high-value fuels from waste biomass still faces numerous challenges regarding the stable operation of bio-oil hydro-upgrading equipment and the service life of catalysts. Bio-oil is an unstable oil product due to its high oxygen content and large amounts of low-boiling-point volatile substances. During high-temperature heating, a series of polymerization or polycondensation reactions occur, causing coking-prone components to clog the reactor bed. Studies have shown that the ebullated bed hydrogenation process exhibits excellent deoxygenation performance for bio-crude and can achieve a high level of oil hydroconversion. Nevertheless, bio-crude has poor hydrogen solubility and is difficult to disperse rapidly for catalytic hydrogenation reactions after entering the reactor, leading to coking and clogging of equipment and pipelines, which affects the long-term stable operation of the unit. Therefore, there is an urgent need for a feedstock supply method that helps inhibit coking at the reactor inlet to avoid bed clogging caused by such coking. On the other hand, the hydrodeoxygenation process of bio-crude in the reactor is highly exothermic, making it easy for the unit temperature to get out of control and cause a “temperature runaway” phenomenon. This leads to sintering, structural collapse, and deactivation of the active metal components of the catalyst, which shortens the catalyst service life, increases catalyst preparation costs and unit operation losses, and may even pose significant safety risks in severe cases.

Chinese Invention Patent CN116286067A discloses a method and device for the long-term stable operation of biomass-to-gasoline/diesel production. Although this method uses series-connected deoxygenation and upgrading equipment to overcome the risks of catalyst coking, deactivation, and unit “temperature runaway” caused by single-stage reactions, the products are gasoline and diesel, which fail to meet the standard requirements for biomass aviation fuel and lack the technical capability for direct production of biomass aviation fuel. Additionally, the drying heat consumption and the large amount of hydrogen required for the hydro-upgrading process rely on external supply, increasing the economic cost of operation; the high temperature at the reactor inlet causes coking loss of bio-crude upon entry; and the investment and operation costs of the ebullated bed catalyst addition and removal system are relatively high.

Chinese Invention Patent CN102732304A discloses a naphtha hydrogenation reaction device and hydrogenation reaction method for extending the operation cycle. Although it adds a preheating reactor, a decoking tank, and a heating furnace at the feed end to economically and effectively prolong the hydrogenation operation cycle, the method has shortcomings. The hydrogenation reactors used include a pre-hydrogenation reactor and a main hydrogenation reactor, and after the reaction, the fouling collectors and decoking tanks of both reactors need to be cleaned and reinstalled. This ultimately increases the number of startups and shutdowns, not only extending maintenance time but also raising operation costs, and still failing to ensure the long-term stable operation of the equipment.

U.S. Pat. No. 10,876,056B2 discloses a process and device for hydrotreating heavy oil using a suspended bed. A portion of the oil is mixed with a catalyst to form a mixed oil, which undergoes first and second shearing in sequence to achieve high dispersion and mixing of the catalyst and feedstock oil. However, this method is mainly based on hydrocracking and is not suitable for the hydrodeoxygenation process requirements of biomass pyrolysis oil. It also struggles to adapt to the characteristics of biomass pyrolysis oil, such as high coking tendency, high oxygen content, high polarity, and poor miscibility with hydrocarbons. The cold wall and discharge port of the suspended bed reactor are prone to alternating stress fatigue due to frequent temperature drops and high pressures, reducing the service life of the device.

Chinese Invention Patent CN112442404A adopts zoned independent drying, mixing, and pyrolysis of different types of biomass feedstocks to prepare pyrolytic solids and liquids. This invention requires zoned hot-air drying for different biomass types, resulting in high manual sorting costs, large floor space, long cycle times, and high energy consumption. Furthermore, the economic benefits of biomass semi-coke are far lower than those of biomass aviation fuel.

In summary, although numerous methods and apparatuses have been developed for biomass drying-pyrolysis, bio-oil hydrodeoxygenation and upgrading, pyrolysis coupled with hydro-upgrading for bio-oil production, and hydro-upgrading coupled with isomerization for biomass fuel production, no biomass aviation fuel preparation method or apparatus has been found to fully address the technical challenges of reactor coking and clogging while enabling low-cost, high-efficiency, and long-term stable operation.

Therefore, in response to the technical bottlenecks existing in both simple and complex treatment processes for producing biomass aviation fuel from biomass, there is an urgent need to develop a method and apparatus for preparing biomass aviation fuel with long-term stable operation. This method and apparatus will adopt ultra-high-rate heating to shorten the time window for coking reactions, transfer and decouple coking risks within the reactor, and reduce decoking costs. Simultaneously, it will reduce the energy loss of the heat source for the catalyst, extend the catalyst's service life, break through the technical barriers in biomass aviation fuel preparation, and realize large-scale industrial application.

### SUMMARY

The purpose of the present invention is to address the problems existing in the preparation of biomass fuels in the prior art, such as high cost, difficulty in achieving effective long-term stable operation, and failure to meet the demand for biomass aviation fuel. It provides an apparatus and method for co-producing aviation fuel and chemical feedstock from waste biomass, which not only can obtain high-quality biomass aviation fuel but also has the advantages of low energy consumption and anti-coking, enabling long-term stable operation.

To achieve the above purpose, the present invention adopts the following technical solutions for implementation.

The present invention provides an anti-coking and stably operating apparatus for co-producing aviation fuel and chemical feedstock from waste biomass, which includes: a second-scale biomass drying-coupled pyrolysis and fractionation conversion to bio-crude unit, a bio-crude suspended bed hydrodeoxygenation and upgrading to low-oxygen bio-oil unit, and a low-oxygen bio-oil fixed-bed molecular reconstruction to hydrocarbon aviation fuel unit.

The second-scale biomass drying-coupled pyrolysis and fractionation conversion to bio-crude unit is used for performing second-scale drying and coupled thermal treatment on biomass to obtain bio-crude, pyrolysis gas, and pyrolysis char; it also reforms and converts the pyrolysis gas into green hydrogen as a hydrogen source, with both the bio-crude and the hydrogen source input as reaction feedstocks into the bio-crude suspended bed hydrodeoxygenation and upgrading to low-oxygen bio-oil unit.

The bio-crude suspended bed hydrodeoxygenation and upgrading to low-oxygen bio-oil unit is used for rapidly crossing the coking reaction time point, transferring the coking position, and realizing the spatiotemporal decoupling of coking risk; it then obtains low-oxygen bio-oil through hydrodeoxygenation and upgrading reaction of bio-crude, gas-liquid separation, flash evaporation, and oil-water separation. The hydrogen obtained from gas-liquid separation is purified to serve as a hydrogen source; the heavy oil obtained from flash evaporation is used as circulating slurry; and the organic solution obtained from oil-water separation is reformed to prepare green hydrogen as a hydrogen source.

The low-oxygen bio-oil fixed-bed molecular reconstruction to hydrocarbon aviation fuel unit is used for performing hydro-reconstruction reaction, oil-water separation, and fractionation on low-oxygen bio-oil components to obtain biomass aviation fuel components and bio-naphtha chemical feedstock. The organic solution obtained from oil-water separation is reformed to prepare green hydrogen as a hydrogen source, and the co-produced distillate bio-naphtha obtained from fractionation is used as a hydrogen donor for the bio-crude suspended bed hydrodeoxygenation and upgrading to low-oxygen bio-oil unit.

The second-scale biomass drying-coupled pyrolysis and fractionation conversion to bio-crude unit includes a second-scale dryer, a second-scale pyrolysis reactor, a cyclone separator, a combustion furnace, a cooling tower, and a water-gas shift reactor. The second-scale dryer is connected to the second-scale pyrolysis reactor, and the dried biomass is sent to the second-scale pyrolysis reactor for coupled thermal treatment to obtain pyrolysis oil-gas and pyrolysis char. The pyrolysis oil-gas and pyrolysis char are separated by the cyclone separator; the separated pyrolysis char is returned to the combustion furnace to provide heat for the second-scale dryer and/or the second-scale pyrolysis reactor; the pyrolysis gas discharged from the cooling tower after cooling the separated pyrolysis oil-gas enters the water-gas shift reactor, and green hydrogen is then prepared by the first hydrogen purification device connected to the water-gas shift reactor; the cooled pyrolysis oil is collected by the bio-crude collection device.

The bio-crude suspended bed hydrodeoxygenation and upgrading to low-oxygen bio-oil unit includes a bio-crude mixing tank, a flash reaction thermal start-up mechanism, a suspended bed hydrodeoxygenation and upgrading reactor, and a separator assembly; the bio-crude mixing tank mixes bio-crude, circulating slurry, and a hydrogen donor, which is then premixed with a hydrogen source before being input into the flash reaction thermal start-up mechanism; the flash reaction thermal start-up mechanism rapidly preheats the mixed materials to 200-400° C., transferring the coking risk to itself to achieve spatiotemporal decoupling; the preheated mixed materials undergo a hydrodeoxygenation and upgrading reaction in the suspended bed hydrodeoxygenation and upgrading reactor; the reaction products are subjected to oil-water separation and flash evaporation by the separator assembly to obtain low-oxygen bio-oil.

The flash reaction thermal start-up mechanism includes a flash reaction thermal start-up furnace group and a high-temperature supplementary furnace; the flash reaction thermal start-up furnace group includes more than two flash reaction thermal start-up furnaces, which are used to preheat the mixed materials to 150-300° C. Through a parallel structure, the more than two flash reaction thermal start-up furnaces can simultaneously perform bio-crude preheating and switching decoking during operation, achieving the dual functions of coking inhibition and decoking; the high-temperature supplementary furnace is used to further preheat the mixed materials from the flash reaction thermal start-up furnace group to 200-400° C. The flash reaction thermal start-up furnace, the high-temperature supplementary furnace, and the suspended bed hydrodeoxygenation and upgrading reactor form gradient heating, which can make the raw materials react more thoroughly and improve reaction efficiency and extent. In a preferred implementation, the flash reaction thermal start-up furnace group includes two flash reaction thermal start-up furnaces; when one is switched out for decoking, the other is used to preheat the mixed materials, thereby realizing coking risk transfer without shutting down the equipment. Each flash reaction thermal start-up furnace includes a furnace body, heating tubes arranged inside the furnace body, and electromagnetic induction coils wound around the heating tubes. The heating tubes are designed in a Z-shaped structure to further increase the heat exchange area and improve heat exchange efficiency. The heating rate of the electromagnetic induction coils is 30-50° C./s, and the residence time is 3-5 s to achieve efficient material transportation. Heating the mixed materials in the heating tubes through the electromagnetic induction coils can effectively increase the heating rate, thereby crossing the coking reaction temperature point, avoiding increased carbon deposition in the tubes caused by slow heating, providing high-quality feedstock, and realizing efficient material transportation. The high-temperature supplementary furnace is a conventional heating furnace; through two-stage stepwise preheating, it achieves full utilization of energy and increases the local concentrations of hydrogen and catalyst.

A catalyst for the hydrodeoxygenation and upgrading reaction is also added to the bio-crude mixing tank; the catalyst dosage is controlled by adjusting the circulation state of the catalyst in the operating zone of the suspended bed hydrodeoxygenation and upgrading reactor. Coarse catalysts participate in the internal circulation of the reactor, fine catalysts participate in the external circulation of the reactor, and powdered catalysts are separated and discharged; the discharged catalysts are supplemented through the bio-crude mixing tank. The particle size of the coarse catalysts is 70-100% of the initial catalyst particle size; the particle size of the fine catalysts is 30-70% of the initial catalyst particle size excluding both endpoints; the particle size of the powdered catalysts is 0-30% of the initial catalyst particle size excluding endpoint 0. The initial catalyst refers to the newly added catalyst that has not participated in the reaction, with a particle size range of 10-200 μm.

The interior of the suspended bed hydrodeoxygenation and upgrading reactor sequentially includes a feed inlet, a reaction bed, and a product outlet from bottom to top; a three-phase cyclone separator is also arranged above the reaction bed. An annular gap structure is added to the three-phase cyclone separator, and the specific structure can be referred to CN113816460A. The annular gap structure is used for overflow diversion, and through the inlet-outlet pressure difference caused by self-overflow iterative separation, it recovers the bio-oil dispersed at the outlet, solving the problem of low separation efficiency caused by excessive internal circulation flows and short-circuit flows in the cyclone separator. A spent catalyst replacement port is provided at the horizontal end of the three-phase cyclone separator for replacing the catalyst, reducing the heat source energy loss when replacing deactivated catalysts, and alleviating equipment maintenance and wear caused by frequent switching between high and low pressures and alternating stress fatigue.

The separator assembly includes a hot high-pressure separator, a cold high-pressure separator, a flash tank, and a cold low-pressure separator; the products from the hydrodeoxygenation and upgrading reaction are first subjected to gas-liquid separation by the hot high-pressure separator (the products entering at this time have high temperature and pressure, hence the name hot high-pressure separator); the separated gas phase is cooled by the first cooler and then further separated to obtain hydrogen by the cold high-pressure separator (although the product temperature has decreased at this time, the pressure is still high, hence the name cold high-pressure separator), and the hydrogen is purified by the first hydrogen purification device to serve as a hydrogen source; based on the difference in boiling points, the separated liquid phase is separated into light oil and heavy oil by the flash tank, and the heavy oil is delivered to the bio-crude mixing tank as circulating slurry; the light oil obtained by flash evaporation in the flash tank is cooled by the second cooler, mixed with the liquid phase separated by the cold high-pressure separator, and then subjected to oil-water separation into an oil phase and a water phase by the cold low-pressure separator (the product pressure needs to be controlled at 1-2.5 MPa at this time); the obtained oil phase is low-oxygen bio-oil, and the obtained water phase is an organic solution which is sent to the organic solution reforming hydrogen production reactor; the hydrogen produced is purified by the second hydrogen purification device to obtain green hydrogen. The purpose of the flash tank is to separate light oil and heavy oil, with an operating temperature of 175-350° C. and a pressure of 1-1.7 MPa; in addition, the catalyst is discharged from the flash tank pipeline as discharged oil residue.

In a preferred implementation, a portion (5-10%) of the obtained low-oxygen bio-oil is delivered to the bio-crude mixing tank as circulating slurry, and 90-95% is transported to the low-oxygen bio-oil fixed-bed molecular reconstruction to hydrocarbon aviation fuel unit. The portion used as circulating slurry serves to coat the bio-crude, preventing reaction coking during pipeline transportation and at the feed inlet of the suspended bed.

In addition, to supplement the catalyst for the hydrodeoxygenation and upgrading reaction, catalyst is also added to the bio-crude mixing tank. To enhance the catalytic effect, the suspension state of the catalyst in the operating zone of the suspended bed hydrodeoxygenation and upgrading reactor can be controlled by adjusting the amount of circulating slurry.

The low-oxygen bio-oil fixed-bed molecular reconstruction to hydrocarbon aviation fuel unit is used to perform a hydro-reconstruction reaction on low-oxygen bio-oil to obtain biomass aviation fuel components meeting relevant standards. The low-oxygen bio-oil fixed-bed molecular reconstruction to hydrocarbon aviation fuel unit includes a fixed-bed molecular reconstruction reactor, a recycle separator, a liquid-phase separator, and a fractionation unit; under the action of the hydrogen source from the first hydrogen purification device, the fixed-bed molecular reconstruction reactor conducts a hydro-reconstruction reaction on the low-oxygen bio-oil components. The hydrogen separated from the reaction products by the recycle separator is purified by the first hydrogen purification device before entering the recycle hydrogen compressor, and the separated liquid phase enters the liquid-phase separator to separate an oil phase and a water phase; the oil phase is sent to the fractionation unit to fractionate C₈-C₁₆ hydrocarbon-based biomass aviation fuel and obtain co-produced distillate; the water phase is an organic solution which is transported to the organic solution reforming hydrogen production reactor, and the hydrogen generated is purified by the second hydrogen purification device to obtain green hydrogen.

A micro-nano bubble generator is installed inside the top of the fixed-bed molecular reconstruction reactor for the full mixing of green hydrogen and low-oxygen bio-oil, improving the hydrogen solubility, mass transfer, and heat transfer performance of the biomass pyrolysis oil. For the specific structure of the micro-nano bubble generator, refer to CN111298670A.

The present invention also provides a method for producing biomass aviation fuel, which is carried out using the aforementioned anti-coking and stably operating apparatus for co-producing aviation fuel and chemical feedstock from waste biomass, following the steps below:
S1: subjecting the waste biomass to drying and coupled thermal treatment via the second-scale biomass drying-coupled pyrolysis and fractionation conversion to bio-crude unit to obtain a pyrolysis oil-gas and pyrolysis char, where the pyrolysis oil-gas and pyrolysis char are separated by a cyclone separator; the pyrolysis gas generated by cooling the pyrolysis oil-gas is further subjected to a water-gas shift reaction to prepare green hydrogen as the hydrogen source, with the bio-crude obtained synchronously during the cooling of the pyrolysis oil-gas; and the pyrolysis char is combusted to release heat for supplying energy to biomass drying and coupled thermal treatment;
S2: converting the bio-crude into the low-oxygen bio-oil via the bio-crude suspended bed hydrodeoxygenation and upgrading to low-oxygen bio-oil unit, where the bio-crude, the hydrogen donor, and the circulating slurry are premixed, then mixed with the hydrogen source in a pipeline, and subsequently passed through the flash reaction thermal start-up mechanism to be rapidly brought into a reaction state; the bio-crude is subjected to the hydrodeoxygenation and upgrading reaction to obtain the low-oxygen bio-oil; during the reaction, the separated heavy oil is used as the circulating slurry, the separated hydrogen is purified to serve as the hydrogen source, and the separated organic solution is reformed to prepare green hydrogen as the hydrogen source;
S3: subjecting the low-oxygen bio-oil components to the hydro-reconstruction reaction via the low-oxygen bio-oil fixed-bed molecular reconstruction to hydrocarbon aviation fuel unit to obtain the biomass aviation fuel components, where during the reaction, the separated organic solution is reformed to prepare green hydrogen as the hydrogen source, and the co-produced distillate obtained by fractionation is used as the hydrogen donor.

In the aforementioned step S1, the second-scale drying of biomass is carried out through cyclonic dehydration under conditions of 5-20 s and normal temperature to 85° C.; the temperature of the second-scale coupled thermal treatment (i.e., second-scale pyrolysis) is 400-700° C., with a heating rate of 1000 K/s to 10000 K/s; the generated bio-crude has a water content of less than 30% and an oxygen content of 30-50%; all pyrolysis char is combusted to meet the energy demand for the second-scale drying and second-scale pyrolysis, among which 30-50% is supplied to the second-scale dryer and 50-70% to the second-scale pyrolysis reactor.

In the aforementioned step S2, the premixed materials are pressurized before being mixed with the hydrogen source in the pipeline, which helps the mixed materials quickly pass through the flash reaction thermal start-up furnace group and the high-temperature supplementary furnace to enter the suspended bed hydrodeoxygenation and upgrading reactor; it also facilitates the mixed materials to rapidly enter the reaction state, forming a gas-liquid-solid three-phase reaction feedstock; the hydrogen source used in this step also needs to pass through a recycle hydrogen compressor before use. The hydrodeoxygenation and upgrading reaction of bio-crude is conducted under the following conditions: temperature of 200-400° C., reaction pressure of 8-15 MPa, volume hourly space velocity of 0.6-2.0 h⁻¹, hydrogen-oil ratio of 400:1 to 1500:1, and residence time of 1-4 h; the oxygen content of the resulting product is 0.2-1%.

The catalyst used for the hydrodeoxygenation and upgrading reaction is hard fine particles with a diameter of 10-200 μm (preferably 70-150 μm) (e.g., silica-based or alumina-based supports, with macroscopic shapes including cog-shaped spherical, cylindrical, and granular forms). The active metals loaded on the particles are transition metal elements from Group IIIB to Group IIB of the periodic table, or alloys formed by any two or more of the transition metal elements. The loading amount of the fine catalyst particles accounts for 20-85% of the volume of the suspended bed hydrogenation reactor. Coarse catalysts (70-100% of the particle size of the initial catalyst) undergo internal circulation in the reactor; in the suspended bed reactor, the larger-diameter catalysts are driven by the gas-liquid mixture to flow upward under the cooperation of the cyclone separator and the guiding annular gap component, forming internal circulation of the catalyst, which can achieve complete fluidization of the catalyst in the bed, improve the desulfurization rate, and reduce the catalyst entrainment amount in the biomass pyrolysis oil. Fine catalysts (30-70% of the particle size of the initial catalyst) undergo external circulation outside the reactor; the slightly smaller-diameter catalysts are discharged from the reactor along with the low-oxygen bio-oil and enter the pipeline, reducing catalyst loss. Powdered catalysts (0-30% of the particle size of the initial catalyst) are discharged externally, and the discharged catalysts are supplemented through the bio-crude mixing tank with the supplementary amount consistent with the discharge amount. The suspension state of the catalyst in the operating zone of the suspended bed hydrodeoxygenation and upgrading reactor can be controlled by adjusting the amount of circulating slurry, thereby regulating the amount of catalyst inside and outside the reactor. This avoids equipment damage caused by the interaction of high-temperature and high-pressure alternating stress fatigue and creep, and extends the operating cycle of the apparatus.

In the aforementioned step S3, the hydro-reconstruction reaction of low-oxygen bio-oil is carried out under the following conditions: temperature of 150-450° C., pressure of 5-20 MPa, volume hourly space velocity of 0.25-4.0 h⁻¹, hydrogen-oil ratio of 400:1 to 1500:1, and residence time of 1-4 h. After reconstruction, the final boiling point is 200-300° C.; the main product, biomass aviation fuel, accounts for 50-60% of the total liquid yield, which is C₈-C₁₆ long-chain alkanes meeting the biomass aviation fuel standards of ASTM D7566 or GB 6537-2018. The co-produced distillate is bio-naphtha, and its components with a boiling point higher than that of the biomass aviation fuel are used as a hydrogen donor to participate in the circulation.

Compared with the prior art, the anti-coking and stably operating apparatus and method for co-producing aviation fuel and chemical feedstock from waste biomass provided by the present invention have the following beneficial effects:

1) Constructs a Full-Process Coupled Hydrogen and Heat Self-Sustaining Operation Mode, Realizing Self-Supply of Drying Heat and Upgrading Hydrogen Required for the Conversion Process, and Solving the Problem of High Operating Cost in Conventional Bio-Oil Conversion.

By using the product pyrolysis char as an energy and heat supply material in the second-scale biomass drying-coupled pyrolysis and fractionation conversion to bio-crude unit, and the green hydrogen produced by water-gas shift of pyrolysis gas and reforming and purification of organic solution for hydrodeoxygenation, upgrading and reconstruction reactions, a “closed-cycle operation” heat source utilization and self-supply hydrogen mode is realized. This solves the problems of high drying cost and high hydrogen usage cost in the conventional process from waste biomass to oil products.

2) Sets Up a Flash Reaction Thermal Start-Up Mechanism with Stepwise Temperature Rise for Coking Inhibition and Online Switching for Decoking, Realizing Spatiotemporal Decoupling of Coking Risk and Solving the Problem of Continuous and Stable Operation of the Apparatus.

The flash reaction thermal start-up mechanism for bio-oil reaction is set to transfer the coking risk point of bio-oil in the reactor to the outside of the reactor, realizing the spatial decoupling between the core reaction zone and the coking risk zone; the flash reaction thermal start-up mechanism has the characteristic of stepwise temperature rise, which can quickly cross the coking-prone temperature point and enter the reaction temperature, realizing the temporal decoupling between the bio-oil heating process and the coking process; the flash reaction thermal start-up mechanism has the ability of switching and decoking, realizing on-line decoking without shutting down the apparatus, and achieving the temporal decoupling between the continuous operation process and the decoking maintenance process of the apparatus. The comprehensive spatiotemporal decoupling design of coking risk solves the problem of continuous and stable operation of the apparatus.

3) the Present Invention Realizes Cyclonic Internal Circulation of the Catalyst, Extends the Service Life of the Catalyst, Overcomes the Problems of High-Temperature and High-Pressure Alternating Stress Fatigue and Creep of the Equipment, and Ensures Long-Term Operation of the Apparatus.

By constructing a three-phase cyclone separator and a self-overflow annular gap component in the suspended bed hydrodeoxygenation and upgrading reactor, the cyclonic internal circulation of the catalyst is realized, and the service life of the catalyst is extended; the heat source energy consumption caused by catalyst replacement is reduced, and the extended maintenance time caused by bed pressure drop loss due to valve jamming, wear and internal leakage is shortened; the problem of low separation efficiency in the cyclone separator is solved by the internal annular gap, the resource recovery is improved, and the long-term operation of the apparatus is guaranteed.

### BRIEF DESCRIPTION OF THE DRAWINGS

FIG. 1 is a schematic flow diagram of the anti-coking and stably operating apparatus for co-producing aviation fuel and chemical feedstock from waste biomass provided by the embodiment of the present invention;

FIG. 2 is a schematic structural diagram of the flash reaction thermal start-up furnace group;

FIG. 3 is a schematic structural diagram of the suspended bed hydrodeoxygenation and upgrading reactor;

FIG. 4 shows the operation status of the device and the change trend of product yield within 3 months in Embodiment 1;

FIG. 5 shows the operation status of the device and the change trend of product yield within 3 months in Embodiment 2;

### COMPONENTS, PARTS AND NUMBERS IN THE FIGURES

1. second-scale biomass drying-coupled pyrolysis and fractionation conversion to bio-crude unit; 11. second-scale dryer; 12. second-scale pyrolysis reactor; 13. cyclone separator; 14. combustion furnace; 15. cooling tower; 16. water-gas shift reactor; 17. first hydrogen purification device; 18. bio-crude collection device; 19. recycle hydrogen compressor; 110. hydrogen donor storage; 111. heat exchanger;
2. bio-crude suspended bed hydrodeoxygenation and upgrading to low-oxygen bio-oil unit; 21. bio-crude mixing tank; 21-1. circulation pump; 22. flash reaction thermal start-up furnace group; 22-1. feed mixing pipeline; 22-2. steam passage; 22-3. flash reaction thermal start-up furnace A; 22-4. flash reaction thermal start-up furnace B; 22-5. electromagnetic induction coil; 22-6. mixed material outlet; 23. high-temperature supplementary furnace; 24. suspended bed hydrodeoxygenation and upgrading reactor; 24-1. feed inlet; 24-2. reaction bed; 24-3. product outlet; 24-4. three-phase cyclone separator; 24-5. annular gap structure; 24-6. spent catalyst replacement port; 25. hot high-pressure separator; 26. cold high-pressure separator; 27. flash tank; 28. cold low-pressure separator; 29. organic solution reforming hydrogen production reactor; 210. steam generator; 211. first cooler; 212. second cooler;
3. low-oxygen bio-oil fixed-bed molecular reconstruction to hydrocarbon aviation fuel unit; 31. fixed-bed molecular reconstruction reactor; 32. recycle separator; 33. liquid-phase separator; 34. fractionation unit; 35. second hydrogen purification device; 36. first heater; 37. second heater.

### DETAILED DESCRIPTION OF THE EMBODIMENTS

The technical solutions of the embodiments of the present invention will be clearly and completely described below with reference to the accompanying drawings. Obviously, the described embodiments are only a part of the embodiments of the present invention, not all of them. Based on the embodiments of the present invention, all other embodiments obtained by those of ordinary skill in the art without making creative efforts shall fall within the scope of the present invention.

### Embodiment 1

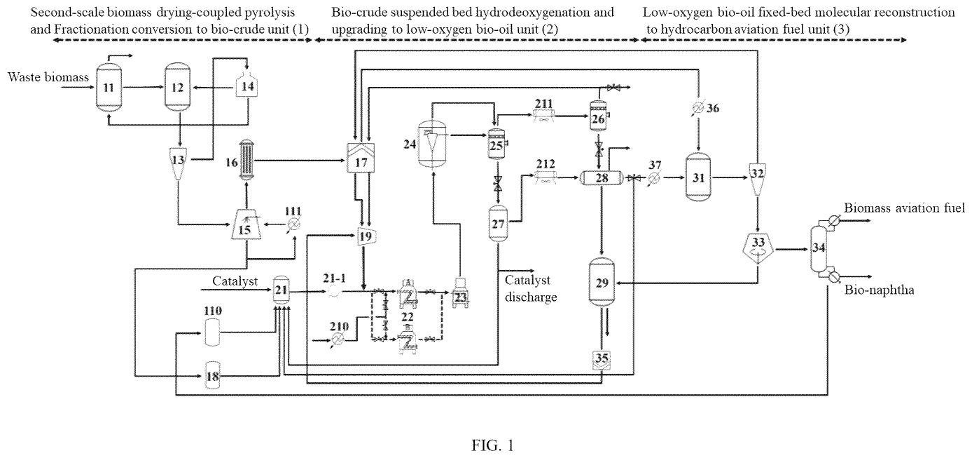

This embodiment provides an anti-coking and stably operating apparatus for co-producing aviation fuel and chemical feedstock from waste biomass. As shown in FIG. 1, the apparatus includes a second-scale biomass drying-coupled pyrolysis and fractionation conversion to bio-crude unit 1, a bio-crude suspended bed hydrodeoxygenation and upgrading to low-oxygen bio-oil unit 2, and a low-oxygen bio-oil fixed-bed molecular reconstruction to hydrocarbon aviation fuel unit 3. Through the second-scale biomass drying-coupled pyrolysis and fractionation conversion to bio-crude unit 1, biomass is dried at normal or low temperature and then converted into bio-crude, pyrolysis gas, and pyrolysis char through low-temperature pyrolysis. All pyrolysis char is combusted to supply heat; the pyrolysis gas is subjected to water-gas shift reaction and purification to produce green hydrogen, which is introduced into the bio-crude suspended bed hydrodeoxygenation and upgrading to low-oxygen bio-oil unit 2. A flash reaction thermal start-up mechanism is configured to transfer the coking risk at the reactor inlet. A three-phase cyclone separator is arranged in the suspended bed hydrodeoxygenation and upgrading reactor to realize long-life and low-energy consumption circulation of the catalyst. Finally, in the low-oxygen bio-oil fixed-bed molecular reconstruction to hydrocarbon aviation fuel unit 3, C₈-C₁₆ hydrocarbon biomass aviation fuel is produced by fractionation, and biomass naphtha is coproduced as a hydrogen donor. The organic solution generated in the process is reformed to produce hydrogen, which participates in long-term cyclic operation.

(1) Second-Scale Biomass Drying Coupled with Pyrolysis and Fractionation Conversion to Bio-Crude Unit

As shown in FIG. 1, the second-scale biomass drying-coupled pyrolysis and fractionation conversion to bio-crude unit 1 is used for second-scale drying and coupled thermal treatment of biomass to obtain bio-crude, pyrolysis gas, and pyrolysis char. The pyrolysis gas is converted into green hydrogen as a hydrogen source, and both the bio-crude and the hydrogen source are input as reaction feedstocks into the bio-crude suspended bed hydrodeoxygenation and upgrading to low-oxygen bio-oil unit 2.

The second-scale biomass drying-coupled pyrolysis and fractionation conversion to bio-crude unit 1 includes a second-scale dryer 11, a second-scale pyrolysis reactor 12, a cyclone separator 13, a combustion furnace 14, a cooling tower 15, a water-gas shift reactor 16, a first hydrogen purification device 17, and a bio-crude collector 18.

The second-scale dryer 11 is connected to the second-scale pyrolysis reactor 12, and the second-scale pyrolysis reactor 12 is connected to the cyclone separator 13. The solid outlet of the cyclone separator 13 is in communication with the inlet of the combustion furnace 14, and the outlet of the combustion furnace 14 is connected to the second-scale dryer 11 and the second-scale pyrolysis reactor 12 respectively. The separated pyrolysis char serves as a heat source in the combustion furnace 14 to supply energy to the second-scale dryer 11 and the second-scale pyrolysis reactor 12.

The gas outlet of the cyclone separator 13 is connected to the cooling tower 15, and the gas outlet of the cooling tower 15 is connected to the water-gas shift reactor 16 and the bio-crude collector 18. Furthermore, the pipeline of the cooling tower 15 is connected to a heat exchanger 111, and returns to the cooling tower after heat exchange. The pyrolysis gas discharged from the cooling tower after cooling the separated pyrolysis oil-gas enters the water-gas shift reactor. In the water-gas shift reactor 16, CO₂ in the pyrolysis gas is converted through the water-gas shift reaction to purify H₂, and the obtained green hydrogen is further purified by the first hydrogen purification device 17 before being supplied to the bio-crude suspended bed hydrodeoxygenation and upgrading to low-oxygen bio-oil unit 2 and the low-oxygen bio-oil fixed-bed molecular reconstruction to hydrocarbon aviation fuel unit 3.

The aforementioned second-scale pyrolysis reactor 12 is a downflow fluidized bed reactor, and its specific structure can be referred to CN116286067A. The aforementioned first hydrogen purification device is a pressure swing adsorption (PSA) hydrogen purification device.

### (2) Bio-Crude Suspended Bed Hydrodeoxygenation and Upgrading to Low-Oxygen Bio-Oil Unit

The bio-crude suspended bed hydrodeoxygenation and upgrading to low-oxygen bio-oil unit 2 is used to achieve spatiotemporal decoupling by enabling reaction feedstocks to rapidly enter the reaction state. Subsequently, low-oxygen bio-oil (with an oxygen content of less than 1%) is obtained through hydrodeoxygenation and upgrading reactions, gas-liquid separation, flash evaporation, and oil-water separation. The hydrogen separated by gas-liquid separation is purified and used as a hydrogen source; the heavy oil obtained from flash evaporation serves as circulating slurry; and the organic solution from oil-water separation is reformed to produce green hydrogen as a hydrogen source.

In a specific implementation, as shown in FIG. 1, the bio-crude suspended bed hydrodeoxygenation and upgrading to low-oxygen bio-oil unit 2 includes a bio-crude mixing tank 21, a flash reaction thermal start-up mechanism, a suspended bed hydrodeoxygenation and upgrading reactor 24, and a separator assembly.

The bio-crude mixing tank 21 mixes bio-crude, circulating slurry, hydrogen donor, and catalyst for the hydrodeoxygenation and upgrading reaction. After passing through a circulation pump 21-1, the mixture is further combined with the hydrogen source and steam before being fed into the flash reaction thermal start-up mechanism. The hydrogen source is supplied by a recycle hydrogen compressor 19 connected to the first hydrogen purification device 17. Steam is provided by a steam generator 210 primarily for coke removal.

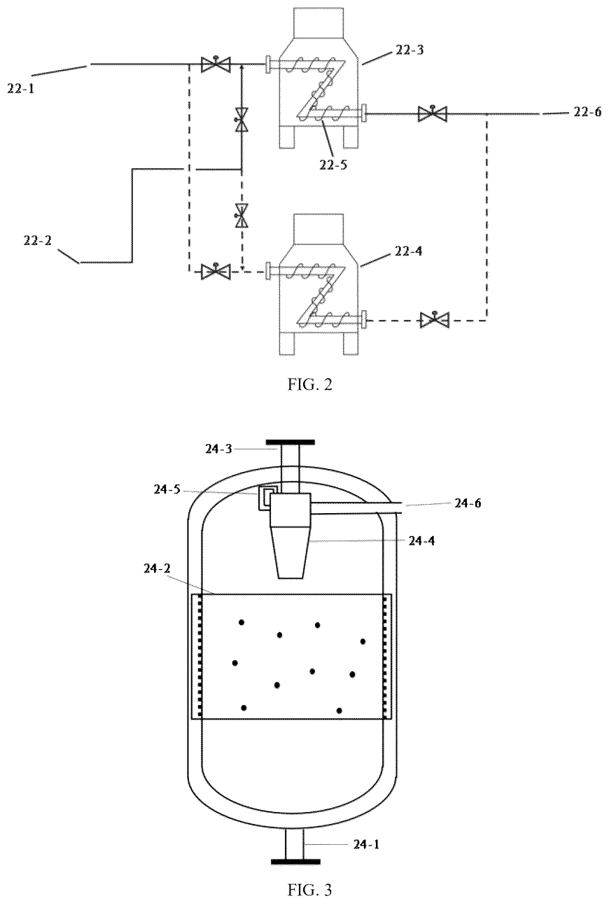

The flash reaction thermal start-up mechanism rapidly preheats the mixed feedstock. The flash reaction thermal start-up mechanism includes a flash reaction thermal start-up furnace group 22 and a high-temperature supplementary furnace 23 connected in series therewith. As shown in FIG. 2, the flash reaction thermal start-up furnace group includes two flash reaction thermal start-up furnaces-flash reaction thermal start-up furnace A 22-3 and flash reaction thermal start-up furnace B 22-4. The inlets of flash reaction thermal start-up furnace A 22-3 and flash reaction thermal start-up furnace B 22-4 are both connected to a feed mixing pipeline 22-1 and a steam passage 22-2 linked to the steam generator 210, with valves installed on each connecting pipeline. The feed mixing pipeline is connected to the recycle hydrogen compressor via a pipeline. The outlets of flash reaction thermal start-up furnace A 22-3 and flash reaction thermal start-up furnace B 22-4 are both connected to a mixed material outlet 22-6, with valves also installed on the connecting pipelines. Flash reaction thermal start-up furnace A 22-3 and flash reaction thermal start-up furnace B 22-4 have the same structure, each including a furnace body, heating tubes arranged inside the furnace body, and electromagnetic induction coils wound around the heating tubes. The heating tubes are thick circular tubes designed in a Z-shape to increase the heat exchange area and improve exchange efficiency, with 6 to 9 sets of electromagnetic induction coils sleeved on each tube. Heating via the electromagnetic induction coils can increase the heating rate, allowing the feedstock to cross the coking reaction temperature point, avoiding increased carbon deposition in the tubes caused by slow heating, providing high-quality feed, and achieving efficient material transportation. The high-temperature supplementary furnace is used to further preheat the mixed materials from the flash reaction thermal start-up furnace group. The high-temperature supplementary furnace 23 is a basic heating furnace, and its outlet is connected to the inlet of the suspended bed hydrodeoxygenation and upgrading reactor 24.

As shown in FIG. 3, the interior of the suspended bed hydrodeoxygenation and upgrading reactor 24 sequentially includes a feed inlet 24-1, a reaction bed 24-2, and a product outlet 24-3 from bottom to top. A three-phase cyclone separator 24-4 is also arranged above the reaction bed 24-2. For the specific structure of the three-phase cyclone separator 24-4, reference may be made to CN113816460A. The annular gap structure 24-5 added to the three-phase separator solves the problem of low separation efficiency caused by excessive internal circulation flow and short-circuit flow in the cyclone. A spent catalyst replacement port 24-6 is provided at the horizontal end of the three-phase cyclone separator for catalyst replacement, which reduces the heat energy loss when replacing deactivated catalysts and mitigates equipment maintenance and wear caused by frequent high-low pressure switching and alternating stress fatigue. The catalyst used in the suspended bed hydrodeoxygenation and upgrading reactor is 50 μm fine particles, with nickel and molybdenum as the supported active metals. The loading volume of the catalyst particles accounts for 35% of the volume of the suspended bed hydrodeoxygenation and upgrading reactor. The suspension state of the catalyst in the operating zone of the suspended bed hydrodeoxygenation and upgrading reactor 24 is controlled by adjusting the amount of circulating slurry. The hydrogen-oil ratio of the hydrodeoxygenation and upgrading reaction is controlled by regulating the amount of the hydrogen source.

The separator assembly includes a hot high-pressure separator 25, a cold high-pressure separator 26, a flash tank 27, and a cold low-pressure separator 28. The products from the hydrodeoxygenation and upgrading reaction are first subjected to gas-liquid separation in the hot high-pressure separator 25; the separated gas phase passes through a first cooler 211 and is further separated in the cold high-pressure separator 26 to recover hydrogen, which is then purified by the first hydrogen purification device 17; the separated liquid phase is fed into the flash tank to separate light oil and heavy oil, and the heavy oil is recycled back to the bio-crude mixing tank 21 as circulating slurry through bed fluidization circulation; the light oil obtained by flash evaporation in the flash tank 27 passes through a second cooler 212, is mixed with the liquid phase separated from the cold high-pressure separator 26, and is then subjected to oil-water separation in the cold low-pressure separator 28. The resulting oil phase is low-oxygen bio-oil, and the resulting aqueous phase is organic solution. The lower end of the cold low-pressure separator 28 is connected to an organic solution reforming hydrogen production reactor. The hydrogen produced by reforming the organic solution in the organic solution reforming hydrogen production reactor is purified by a second hydrogen purification device to obtain green hydrogen.

In one implementation, part of the obtained low-oxygen bio-oil is transported to the bio-crude mixing tank 21 as circulating slurry through a pipeline, and the other part is delivered to the low-oxygen bio-oil fixed-bed molecular reconstruction to hydrocarbon aviation fuel unit 3 through a pipeline, with valves installed on each pipeline.

The aforementioned organic solution reforming hydrogen production reactor adopts conventional equipment disclosed in the art, and its specific structure is referenced in CN213231513U.

### (3) Low-Oxygen Bio-Oil Fixed-Bed Molecular Reconstruction to Hydrocarbon Aviation Fuel Unit

The low-oxygen bio-oil fixed-bed molecular reconstruction to hydrocarbon aviation fuel unit 3 is used to subject low-oxygen bio-oil to hydro-reconstruction reaction, oil-water separation, and fractionation to obtain biomass aviation fuel components. The waste liquid from oil-water separation is reformed to produce green hydrogen as a hydrogen source, and the co-produced distillate from fractionation serves as a hydrogen donor.

The low-oxygen bio-oil fixed-bed molecular reconstruction to hydrocarbon aviation fuel unit 3 includes a fixed-bed molecular reconstruction reactor 31, a recycle separator 32, a liquid-phase separator 33, and a fractionation unit 34.

Low-oxygen bio-oil is heated by a heater 36 and then fed into the fixed-bed molecular reconstruction reactor 31. Under the action of the hydrogen source from the first hydrogen purification device 17, the low-oxygen bio-oil undergoes a hydro-reconstruction reaction.

The products from the fixed-bed molecular reconstruction reactor 31 pass through the recycle separator 32. The separated hydrogen is purified by the first hydrogen purification device 17, and the separated liquid phase enters the liquid-phase separator 33 for oil-water separation. The oil phase is sent to the fractionation unit 34 to fractionate C₈-C₁₆ hydrocarbon-based biomass aviation fuel, with naphtha obtained as a co-produced distillate. The aqueous phase is waste liquid, which is fed into the organic solution reforming hydrogen production reactor. The hydrogen produced therefrom is purified by the second hydrogen purification device 35 to obtain green hydrogen.

The fixed-bed molecular reconstruction reactor adopts a fixed-bed reactor structure, the specific details of which are referenced in CN118755495A. Additionally, a micro-nano bubble generator is installed inside the top of the fixed-bed molecular reconstruction reactor 31 to achieve full mixing of green hydrogen and low-oxygen bio-oil, thereby improving the hydrogen solubility of the oil product as well as mass and heat transfer efficiency. The structure of the micro-nano bubble generator is referenced in CN111298670A. The catalyst used in the fixed-bed molecular reconstruction reactor 31 is aluminum oxide, with nickel, molybdenum, and zirconium as the supported active metals. The specific surface area of the catalyst is 180 m²/g.

The aforementioned second hydrogen purification device 35 has the same structure as the first hydrogen purification device 17.

In this embodiment, biomass is used as the raw material, and the above-mentioned anti-coking and stably operating apparatus for co-producing aviation fuel and chemical feedstock from waste biomass is employed to prepare biomass aviation fuel according to the following steps:
S1: Biomass is subjected to drying and coupled thermal treatment via the second-scale biomass drying-coupled pyrolysis and fractionation conversion to bio-crude unit 1 to obtain pyrolysis oil-gas and pyrolytic char. The pyrolysis oil-gas and pyrolytic char are separated by a cyclone separator. The pyrolysis gas generated by cooling the pyrolysis oil-gas is further subjected to a water-gas shift reaction to produce green hydrogen as a hydrogen source, while bio-crude is obtained simultaneously during the cooling of the pyrolysis oil-gas. The pyrolytic char is combusted to release heat, which provides energy for biomass drying and coupled thermal treatment.

In this embodiment, waste straw is used as the biomass. The biomass is added from the top of the second-scale dryer 11 for drying treatment—with a drying time of 8 seconds and a drying temperature of 85° C., the moisture content of the biomass is reduced from 35% to 8%. The dried biomass is discharged from the bottom of the second-scale dryer 11 and enters the second-scale pyrolysis reactor 12 from the top. It is heated to 600° C. to undergo rapid pyrolysis, with a heating rate of 1000 K/s and a pyrolysis oil-gas cooling rate of 500 K/s during the pyrolysis process. The pyrolytic char and pyrolysis oil-gas generated by pyrolysis are separated by the cyclone separator; the separated pyrolytic char directly enters the combustion furnace. A small portion (approximately 30%) of the hot gas flow generated in the combustion furnace 14 enters the second-scale dryer 11, and most (approximately 70%) enters the second-scale pyrolysis reactor 12. The pyrolysis oil-gas generated by pyrolysis (being high-temperature oil-gas) passes through the cooling tower 15 and is cooled to 60° C. to obtain bio-crude. A part of the bio-crude is further cooled to 30° C. via the heat exchanger 111 and then returned to the cooling tower to spray the high-temperature oil-gas from the cyclone separator 13; the other part of the cooled bio-crude enters the bio-crude collection device 18. The properties of the bio-crude are shown in Tables 1 and 2. The pyrolysis gas discharged from the cooling tower is converted into green hydrogen via the water-gas shift reactor 16, and the green hydrogen is purified by the first hydrogen purification device before being supplied to the suspended bed hydrodeoxygenation and upgrading reactor 24 and the fixed-bed molecular reconstruction reactor 31.
S2: Bio-crude is converted into low-oxygen bio-oil via the bio-crude suspended bed hydrodeoxygenation and upgrading to low-oxygen bio-oil unit 2. Bio-crude, hydrogen donor, and circulating slurry are premixed, then mixed with the hydrogen source in the pipeline, and subsequently passed through the flash reaction thermal start-up mechanism to rapidly enter the reaction state. The bio-crude undergoes hydrodeoxygenation and upgrading reactions to obtain low-oxygen bio-oil. During the reaction, the separated heavy oil is used as circulating slurry, the separated hydrogen is purified to serve as a hydrogen source, and the separated organic solution is reformed to produce green hydrogen as a hydrogen source.

Bio-crude, hydrogen donor, and circulating slurry are mixed in the bio-crude mixing tank 21. The mixed materials are pressurized by the circulation pump 21-1, mixed with hydrogen from the recycle hydrogen compressor 19 in the pipeline, and then enter flash reaction thermal start-up furnace A 22-3 to be rapidly heated to 200° C. It is further preheated to 300° C. in the high-temperature supplementary furnace 23 before entering the suspended bed hydrodeoxygenation and upgrading reactor 24. Under high-speed agitation in the suspended bed hydrodeoxygenation and upgrading reactor 24, the mixed materials and spherical catalyst are rapidly heated, mixed, and diluted to undergo hydrodeoxygenation and upgrading reactions. The suspension state of the hydrodeoxygenation and upgrading reaction catalyst is controlled by adjusting the amount of circulating slurry to meet the operating requirements of the suspended bed reactor. The hydrogen-oil ratio of the hydrodeoxygenation and upgrading reaction is regulated by controlling the amount of recycled hydrogen. In this embodiment, the catalyst is fine spherical particles loaded with nickel as the active metal, and the hydrogen-oil volume ratio is 400:1. In this embodiment, the reaction volume hourly space velocity is 0.6 h⁻¹, the reaction pressure is 13.0 MPa, and the reaction temperature is 300° C. The low-oxygen bio-oil product after hydrodeoxygenation and upgrading passes through the hot high-pressure separator 25. The gas phase passes through the first cooler 211 and then enters the cold high-pressure separator 26. The resulting hydrogen separated from the cold high-pressure separator is recovered and sent to the first hydrogen purification device 17. The liquid phase of the low-oxygen bio-oil is introduced into the flash tank 27 (operating at 300° C. and 1.25 MPa), where light oil, heavy oil, and spent catalyst are separated. The heavy oil is recycled back to the bio-crude mixing tank 21 as circulating slurry through bed fluidization circulation. The other outlet of the flash tank 27 is connected to the second cooler 212 and the cold low-pressure separator 28 (pressure controlled at 2 MPa). The lower end of the cold low-pressure separator 28 is connected to the organic solution reforming hydrogen production reactor 29. The product separated by the cold low-pressure separator 28 is low-oxygen bio-oil, which is directly fed into the low-oxygen bio-oil fixed-bed molecular reconstruction to hydrocarbon aviation fuel unit 3.
S3: Low-oxygen bio-oil undergoes hydro-reconstruction reactions via the low-oxygen bio-oil fixed-bed molecular reconstruction to hydrocarbon aviation fuel unit 3 to obtain biomass aviation fuel components. During the reaction, the separated waste liquid is reformed to produce green hydrogen as a hydrogen source, and the co-produced distillate from fractionation serves as a hydrogen donor.

For the reconstruction reaction in this embodiment, the hydrogen-oil ratio is 800:1. In this embodiment, the hydro-reconstruction catalyst is a cog-shaped spherical alumina-based catalyst, the reaction volume hourly space velocity is 0.8 h⁻¹, the reaction pressure is 15.0 MPa, and the reaction temperature is 300° C. The oxygen content in the low-oxygen bio-oil is reduced to 0.1%, and the sulfur content is less than 10 ppm.

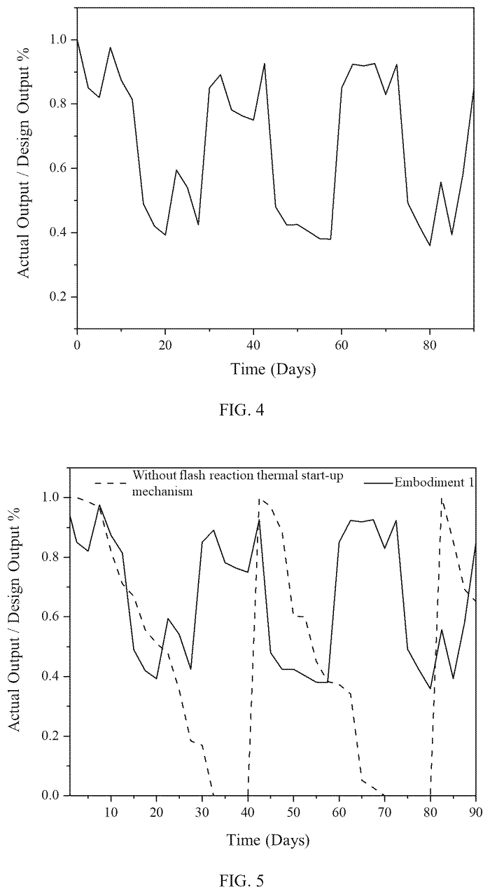

The biomass aviation fuel preparation process in this embodiment can achieve stable operation for 3 months, and the deoxygenated and reconstructed biomass aviation fuel product still meets the sustainable jet fuel standards after 3 months. The overall process energy consumption is reduced by 40%, and the total yield of biomass aviation fuel is increased to 85%. FIG. 4 shows the product yield trend within 3 months. It can be seen from the figure that the anti-coking and stably operating apparatus for co-producing aviation fuel and chemical feedstock from waste biomass provided by the present invention can achieve long-term stable operation, and even coke cleaning does not affect the equipment operation.

TABLE 1
Properties of Straw Bio-crude and Low-oxygen Straw Bio-oil
Produced by Hydrodeoxygenation and Upgrading Reaction

| | | | | Higher | | | | | |
|---|---|---|---|---|---|---|---|---|---|
| | Density | | | Heating | | Elemental Composition | | | |
| | at 15° C. | Viscosity | Moisture | Value | Acid Value | | | | Others |
| Sample | (g/cm³) | (20° C., cp) | (%) | (MJ/kg) | (mgKOH/g) | C(wt %) | H(wt %) | O(wt %) | (wt %) |
| Straw | 1.12 | 82 | 30 | 16.0 | 125 | 40.50 | 8.00 | 51.40 | 0.10 |
| Bio- | | | | | | | | | |
| crude | | | | | | | | | |
| Low- | 0.8 | 1.0 | 0.001 | 45 | 10 | 86.50 | 11.60 | 0.97 | 0.20 |
| oxygen | | | | | | | | | |
| Straw | | | | | | | | | |
| Bio-oil | | | | | | | | | |

TABLE 2
GC-MS Analysis Results of Straw Bio-
crude and Low-oxygen Straw Bio-oil

| | Straw | Low-oxygen |
|---|---|---|
| | Bio-crude | Straw Bio-oil |
| Alcohols | 14.05 | 1.91 |
| Lipids | 7.21 | 1.83 |
| Ketones | 12.5 | 0.31 |
| Aldehydes | 16.42 | 0 |
| Ethers | 0.55 | 0 |
| Carboxylic Acids | 17.62 | 0 |
| Phenols | 16.84 | 0 |
| Alkanes | 3.59 | 58.02 |
| Aromatic Hydrocarbons | 10.98 | 25.32 |
| Unsaturated Hydrocarbons | 0.24 | 1.31 |

TABLE 3
Analysis Results of Straw-Derived Aviation Fuel

| Category | Chemical Composition | Relative Content (%) | Boiling Point (° C.) |
|---|---|---|---|
| Alkanes | 1,5- | 0.38-3.29 | 91.8 |
| | Dimethylcyclopentane | | |
| | Trimethylheptane | 0.38-3.77 | 174 |
| | Octane | 1.26-3.64 | 125.8 |
| | Nonane | 2.44-2.36 | 150 |
| | Propylcyclohexane | 0.24-2.37 | 168 |
| | Butylcyclopentane | 0.22-1.63 | 180.9 |
| | Undecane | 0.53-2.52 | 196 |
| | Dodecane | 0.58-2.36 | 216 |
| | Tridecane | 1.18-1.73 | 235.4 |
| | Cyclopentadecane | 0.22-0.55 | 279.5 |
| | n-Tetradecane | 2.87-3.02 | 253 |
| | Cyclotetradecane | 0.57-1.21 | ≥253 |
| | Pentadecane | 1.15-2.76 | 270 |
| | Hexadecane | 0.83-1.29 | 287 |
| | Heptadecane | 0.41-1.04 | 302 |
| | Octadecane | 0.2-1.06 | 3317 |
| | Nonadecane | 0.2-1.03 | 330 |
| Aromatic | Toluene | 23.77-24.61 | 110.6 |
| Hydrocarbons | p-Xylene | 3.75-4.37 | 138.5 |
| (47.98-49.73%, of | Naphthalene | 1.49-1.63 | 217.9 |
| which monocyclic | 2-Methylnaphthalene | 1.74-2.06 | 241.1 |
| aromatics account for | | | |
| 94.1%) | | | |
| Others (3.68-7.72%) | — | — | — |

Tables 1 and 2 present the analysis results of the components and properties of biomass bio-crude and the low-oxygen bio-oil produced by the hydrodeoxygenation and upgrading reaction. As can be seen from the tables, the quality of the bio-oil product is significantly improved: the yields of alcohols, lipids, ketones, aldehydes and other substances are obviously reduced, while the total content of alkanes and aromatic hydrocarbons is significantly increased, which is conducive to the subsequent reconstruction reaction.

Table 3 shows the analysis results of partial components of the reconstructed biomass aviation fuel. The main product, biomass aviation fuel, accounts for 50-60% of the total liquid yield and contains C₈-C₁₆ alkanes, among which aromatic hydrocarbons account for 47.68-49.73%, meeting the biomass aviation fuel standards of ASTM D7566 or GB 6537-2018.

### Embodiment 2

Compared with Embodiment 1, this embodiment does not include the flash reaction thermal start-up furnace group 22, but includes only one high-temperature supplementary furnace, with other operating conditions and process flows being the same as those in Embodiment 1. Table 4 shows the comparison of the properties of low-oxygen bio-oil between Embodiment 2 and Embodiment 1, Table 5 presents the GC-MS analysis results of low-oxygen bio-oil in Embodiment 2 and Embodiment 1, and FIG. 5 shows the comparison of biomass aviation fuel yield variation between Embodiment 2 and Embodiment 1.

TABLE 4
Comparison of Low-oxygen Bio-oil Properties between Embodiment 2 and Embodiment 1

| | | | | Higher | | | | | |
|---|---|---|---|---|---|---|---|---|---|
| | Density | Viscosity | | Heating | | Elemental Composition | | | |
| | at 15° C. | (20° C., | Moisture | Value | Acid Value | | | | Others |
| Sample | (g/cm³) | cp) | (%) | (MJ/kg) | (mgKOH/g) | C(wt %) | H(wt %) | O(wt %) | (wt %) |
| Embodiment | 0.8 | 1.0 | 0.001 | 45 | 10 | 86.50 | 11.60 | 0.97 | 0.20 |
| 1 Low- | | | | | | | | | |
| oxygen Bio- | | | | | | | | | |
| oil | | | | | | | | | |
| Embodiment | 0.85 | 1.25 | 0.005 | 35 | 13 | 68.4 | 10.8 | 20.4 | 0.4 |
| 2 Low- | | | | | | | | | |
| oxygen Bio- | | | | | | | | | |
| oil | | | | | | | | | |

TABLE 5
GC-MS Analysis Results of Low-oxygen Bio-
oil in Embodiment 2 and Embodiment 1

| | Embodiment 1 | Embodiment 2 |
|---|---|---|
| | Low-oxygen Bio-oil | Low-oxygen Bio-oil |
| Alcohols | 1.91 | 5.6 |
| Lipids | 1.83 | 4.5 |
| Ketones | 0.31 | 4.2 |
| Aldehydes | 0 | 1.2 |
| Ethers | 0 | 4.3 |
| Carboxylic Acids | 0 | 0.19 |
| Phenols | 0 | 22.5 |
| Alkanes | 58.02 | 37 |
| Aromatic Hydrocarbons | 25.32 | 17.36 |
| Unsaturated Hydrocarbons | 1.31 | 3.15 |

After three months of continuous operation, the comparison between the low-oxygen bio-oil obtained in this embodiment and that in Embodiment 1 is shown in Tables 4 and 5. Compared with the process adopted in Embodiment 1, the process in Embodiment 2 lacks the flash reaction thermal start-up furnace group to mitigate raw material coking. Therefore, tar deposition and carbon blockage occur in the suspended bed hydrodeoxygenation and upgrading reactor and pipelines, requiring shutdown for decoking and resulting in a shortened operation cycle of the plant. Without gradient heating of the mixed materials, the reaction of the mixed materials is incomplete, and the reaction efficiency and extent are lower than those in Embodiment 1. As can be seen from Tables 4 and 5, the quality of the bio-oil product obtained without the flash reaction thermal start-up furnace group is significantly lower than that in Embodiment 1: the calorific value of the bio-oil decreases from 45 MJ/kg to 35 MJ/kg, the oxygen content increases from 0.1 wt. % to 20.4 wt. %, the yields of alcohols, lipids, ketones, aldehydes and other substances increase, while the total content of alkanes and aromatic hydrocarbons decreases from 74.34% to 54.36%. The poor quality of the bio-oil hinders the subsequent reconstruction reaction. As can be seen from FIG. 5, the plant cannot realize long-term stable operation and needs to be shut down for maintenance due to coking for 10-20 days.

### Embodiment 3

Compared with Embodiment 1, this embodiment does not incorporate an annular gap structure with flow-guiding function in the suspended bed hydrodeoxygenation and upgrading reactor, resulting in failure to achieve internal catalyst circulation. All other operating conditions and process flows remain the same as those in Embodiment 1. A portion of the catalyst discharged from the suspended bed hydrodeoxygenation and upgrading reactor 24 suffers from severe deactivation, leading to increased catalyst consumption and a 20% rise in material costs as well as valve maintenance costs. This is unfavorable for engineering scale-up, and the stable operation cycle is shortened from 3 months to 2 months. This is attributed to the fact that the catalyst does not participate in the swirling internal circulation, which shortens the catalyst service life. The frequent catalyst replacement increases heat source energy consumption. In addition, the equipment has to withstand the interactive damage failure modes of alternating stress fatigue and creep under high temperature and high pressure conditions, which further causes valve jamming, abrasion and internal leakage, resulting in increased bed pressure drop loss and prolonged maintenance time. Consequently, the high-quality conversion of biomass aviation fuel products cannot be achieved.

### Embodiment 4

Compared with Embodiment 1, the fixed-bed molecular reconstruction reactor 31 in this embodiment does not adopt recycled green hydrogen, while all other operating conditions and process flows are the same as those in Embodiment 1. Table 6 presents a comparison of various parameters of the biomass aviation fuel between Embodiment 4 and Embodiment 1.

TABLE 6
Comparison of Various Parameters of Biomass Aviation
Fuel between Embodiment 4 and Embodiment 1

| | | | | | | Kinematic | |
|---|---|---|---|---|---|---|---|
| | Density | | Flash | | Water | Viscosity at | Freezing |
| | at 20° C. | Acid Value | Point | Distillation | Content | 40° C. | Point |
| Sample | (g/cm³) | (mg/100 mL) | (° C.) | Range (° C.) | (ppm) | (mm²/S) | (° C.) |
| Embodiment | 0.752 | <0.01 | 39 | 200-300 | 50 | 3.47 | −53 |
| 1 Biomass | | | | | | | |
| Aviation | | | | | | | |
| Fuel | | | | | | | |
| Embodiment | 0.797 | <0.02 | 35 | 190-300 | 50 | 3.48 | −46 |
| 4 Biomass | | | | | | | |
| Aviation | | | | | | | |
| Fuel | | | | | | | |

A comparison between the biomass aviation fuel obtained in this embodiment and that in Embodiment 1 is shown in Table 6. Compared with the process in Embodiment 1, the low-oxygen bio-oil in Embodiment 4 is fed into a fixed-bed molecular reconstruction reactor without recycled green hydrogen for deep hydrogenation. Due to the intense heat release of the reconstruction reaction, during the production process of the fixed-bed molecular reconstruction reactor, the heat release rate of the exothermic reaction exceeds the heat transfer rate, leading to temperature runaway and severe thermal excursion of the equipment. This causes structural collapse and sintering deactivation of the active components of the catalyst. As shown in Table 6, the freezing point of the biomass aviation fuel obtained in Embodiment 4 is higher than that in Embodiment 1. This may be attributed to the unstable temperature of the fixed-bed molecular reconstruction reactor. After the catalyst is sintered, carbon deposition occurs and blocks the active sites of the catalyst, resulting in sluggish reaction, poor reconstruction effect, and reduced product yield. Long-term stable operation cannot be achieved, and the operation cycle is shortened from 3 months in Embodiment 1 to 2 months.

### Embodiment 5

Compared with Embodiment 1, in this embodiment, the second-scale biomass drying-coupled pyrolysis and fractionation conversion to bio-crude unit 1, the bio-crude suspended bed hydrodeoxygenation and upgrading to low-oxygen bio-oil unit 2, and the low-oxygen bio-oil fixed-bed molecular reconstruction to hydrocarbon aviation fuel unit 3 operate independently. The waste hydrogen and organic wastewater generated by the hydrodeoxygenation and upgrading system as well as the reconstruction system are directly discharged without treatment. This results in a substantial increase in the supply of external hydrogen sources (hydrogen and hydrogen donors) for the entire process, with the overall process energy consumption increasing by 23% compared with Embodiment 1.

In this embodiment, the processing cost of the waste biomass aviation fuel product is approximately 6,000 CNY per ton of oil product. The external drying heat energy supply cost of the second-scale biomass drying-coupled pyrolysis and fractionation conversion to bio-crude unit 1 is 600 CNY per ton of oil product. When the bio-crude suspended bed hydrodeoxygenation and upgrading to low-oxygen bio-oil unit 2 and the low-oxygen bio-oil fixed-bed molecular reconstruction to hydrocarbon aviation fuel unit 3 operate independently, the cost of externally supplied hydrogen for hydrogenation is 1,500 CNY per ton of oil product. The total process cost increases by 35% compared with Embodiment 1, mainly due to the external supply of drying heat energy and hydrogen sources.

In summary, the anti-coking and stably operating apparatus and method for co-producing aviation fuel and chemical feedstock from waste biomass provided by the present invention realize low-energy-consumption pyrolysis for green hydrogen and bio-crude production through second-scale drying-coupled pyrolysis of biomass at temperatures below 100° C. Pyrolysis oil-gas and tar are reformed and purified to produce hydrogen, which is supplied as the hydrogen source for hydrodeoxygenation, upgrading and reconstruction reactions. The flash reaction thermal start-up furnace group preheats the bio-crude, circulating slurry, and hydrogen source. With the operation mode of stepwise temperature rise for coking inhibition and online switchover for decoking, the coking risk is transferred from the reactor inlet to the flash reaction thermal start-up furnace group, achieving spatiotemporal decoupling of coking risk and solving the potential safety hazards caused by equipment blockage. In the suspended bed hydrodeoxygenation and upgrading reactor, the large-diameter catalyst realizes internal circulation through the cooperation of the cyclone separator and the annular gap structure with flow-guiding function, overcoming the problems of alternating stress fatigue and creep of equipment under high temperature and high pressure conditions, prolonging catalyst service life, and ensuring long-term stable operation of the equipment. By suppressing the temperature runaway of the fixed-bed reconstruction reactor for producing biomass aviation fuel, the long-term stable operation of the equipment is achieved. The hydrogen produced during the process is purified and sent to the recycle hydrogen compressor for recycling. As a result, the overall process energy consumption of the equipment is reduced by 30%, the product processing cost is reduced by 35%, the total yield of biomass aviation fuel is increased to 85%, and the equipment can operate continuously and stably for 3 months. The biomass aviation fuel product complies with the specifications of bio-based jet fuel in ASTM D7566 or GB 6537-2018, and the product carbon footprint analysis shows an emission of less than 28.2 g CO₂/GJ, meeting the EU sustainable fuel standards.

Those skilled in the art will appreciate that the embodiments described herein are provided to assist readers in understanding the principles of the present invention, and it should be understood that the protection scope of the present invention is not limited to such specific statements and embodiments. Based on the technical inspirations disclosed in the present invention, those skilled in the art can make various other specific modifications and combinations without departing from the essence of the present invention, and such modifications and combinations shall still fall within the protection scope of the present invention.

What is claimed is:

1. An anti-coking and stably operating apparatus for co-producing aviation fuel and chemical feedstock from waste biomass, comprising: a second-scale biomass drying-coupled pyrolysis and fractionation conversion to bio-crude unit, a bio-crude suspended bed hydrodeoxygenation and upgrading to low-oxygen bio-oil unit, and a low-oxygen bio-oil fixed-bed molecular reconstruction to hydrocarbon aviation fuel unit; wherein
the second-scale biomass drying-coupled pyrolysis and fractionation conversion to bio-crude unit is used to obtain a bio-crude, a pyrolysis gas, and a pyrolysis char; the pyrolysis gas is reformed into green hydrogen as a hydrogen source, and both the bio-crude and the hydrogen source are input as reaction raw materials into the bio-crude suspended bed hydrodeoxygenation and upgrading to low-oxygen bio-oil unit;
the bio-crude suspended bed hydrodeoxygenation and upgrading to low-oxygen bio-oil unit is used to rapidly cross a coking reaction time point, transfer a coking position, and realize spatiotemporal decoupling of coking risk; then, a low-oxygen bio-oil is obtained through a hydrodeoxygenation and upgrading reaction of the bio-crude, gas-liquid separation, flash evaporation, and oil-water separation; hydrogen obtained from gas-liquid separation is purified to serve as the hydrogen source; a heavy oil obtained from flash evaporation is used as a circulating slurry; an organic solution obtained from oil-water separation is reformed to prepare green hydrogen as the hydrogen source; the bio-crude suspended bed hydrodeoxygenation and upgrading to low-oxygen bio-oil unit comprises a bio-crude mixing tank, a flash reaction thermal start-up mechanism, a suspended bed hydrodeoxygenation and upgrading reactor, and a separator assembly; the bio-crude mixing tank mixes the bio-crude, the circulating slurry, and a hydrogen donor, which is then premixed with the hydrogen source and input into the flash reaction thermal start-up mechanism to transfer the coking risk to the flash reaction thermal start-up mechanism and realize spatiotemporal decoupling; preheated mixed materials undergo the hydrodeoxygenation and upgrading reaction in the suspended bed hydrodeoxygenation and upgrading reactor; reaction products are subjected to oil-water separation and flash evaporation through the separator assembly to obtain the low-oxygen bio-oil; the flash reaction thermal start-up mechanism comprises a flash reaction thermal start-up furnace group and a high-temperature supplementary furnace; the flash reaction thermal start-up furnace group comprises more than two flash reaction thermal start-up furnaces for preheating a mixed material to 150-300° C.; the more than two flash reaction thermal start-up furnaces operate in a parallel structure, enabling simultaneous bio-crude preheating and switching decoking to achieve dual functions of coking inhibition and decoking; the high-temperature supplementary furnace is used to further preheat the mixed material from the flash reaction thermal start-up furnace group to 200-400° C., realizing full utilization of energy through two-stage stepped preheating; an interior of the suspended bed hydrodeoxygenation and upgrading reactor sequentially comprises a feed inlet, a reaction bed, and a product outlet from bottom to top; a three-phase cyclone separator and an annular gap are further arranged above the reaction bed;
the low-oxygen bio-oil fixed-bed molecular reconstruction to hydrocarbon aviation fuel unit is used to perform a hydro-reconstruction reaction, oil-water separation, and fractionation on low-oxygen bio-oil components to obtain biomass aviation fuel components and bio-naphtha chemical feedstock; an organic solution obtained from oil-water separation is reformed to prepare green hydrogen as the hydrogen source; co-produced distillate bio-naphtha obtained by fractionation is used as the hydrogen donor for the bio-crude suspended bed hydrodeoxygenation and upgrading to low-oxygen bio-oil unit.

2. The anti-coking and stably operating apparatus for co-producing aviation fuel and chemical feedstock from waste biomass according to claim 1, wherein the second-scale biomass drying-coupled pyrolysis and fractionation conversion to bio-crude unit comprises a second-scale dryer, a second-scale pyrolysis reactor, a cyclone separator, a combustion furnace, a cooling tower, and a water-gas shift reactor; the second-scale dryer is connected to the second-scale pyrolysis reactor, and dried biomass is sent to the second-scale pyrolysis reactor for coupled thermal treatment to obtain a pyrolysis oil-gas and the pyrolysis char; the pyrolysis oil-gas and the pyrolysis char are separated by the cyclone separator, the separated pyrolysis char is returned to the combustion furnace to provide heat for the second-scale dryer and/or the second-scale pyrolysis reactor; the pyrolysis gas discharged from the cooling tower after cooling the separated pyrolysis oil-gas enters the water-gas shift reactor, and then green hydrogen is prepared by a first hydrogen purification device connected to the water-gas shift reactor; a cooled pyrolysis oil, i.e., the bio-crude, is collected by a bio-crude collection device.

3. The anti-coking and stably operating apparatus for co-producing aviation fuel and chemical feedstock from waste biomass according to claim 1, wherein the bio-crude mixing tank is further added with a catalyst for the hydrodeoxygenation and upgrading reaction; a catalyst dosage is controlled by adjusting a circulation state of the catalyst in an operating zone of the suspended bed hydrodeoxygenation and upgrading reactor; coarse catalysts participate in an internal circulation of the reactor, fine catalysts participate in an external circulation of the reactor, and powdered catalysts are separated and discharged; discharged catalysts are supplemented through the bio-crude mixing tank; a particle size of the coarse catalysts is 70-100% of an initial catalyst particle size; a particle size of the fine catalysts is 30-70% of the initial catalyst particle size excluding both endpoints; a particle size of the powdered catalysts is 0-30% of the initial catalyst particle size excluding endpoint 0.

4. The anti-coking and stably operating apparatus for co-producing aviation fuel and chemical feedstock from waste biomass according to claim 1, wherein the separator assembly in the bio-crude suspended bed hydrodeoxygenation and upgrading to low-oxygen bio-oil unit comprises a hot high-pressure separator, a cold high-pressure separator, a flash tank, and a cold low-pressure separator; the products from the hydrodeoxygenation and upgrading reaction are first subjected to gas-liquid separation by the hot high-pressure separator; a separated gas phase is further separated to obtain hydrogen by the cold high-pressure separator, and the hydrogen is purified by a first hydrogen purification device to serve as the hydrogen source; based on a difference in boiling points, a separated liquid phase is separated into a light oil and the heavy oil by the flash tank, and the heavy oil is delivered to the bio-crude mixing tank as the circulating slurry; the light oil obtained by flash evaporation in the flash tank is mixed with a liquid phase separated by the cold high-pressure separator, and then subjected to oil-water separation into an oil phase and a water phase by the cold low-pressure separator; the obtained oil phase is the low-oxygen bio-oil, and the obtained water phase is the organic solution which is sent to an organic solution reforming hydrogen production reactor; hydrogen produced is purified by a second hydrogen purification device to obtain green hydrogen.

5. The anti-coking and stably operating apparatus for co-producing aviation fuel and chemical feedstock from waste biomass according to claim 1, wherein the low-oxygen bio-oil fixed-bed molecular reconstruction to hydrocarbon aviation fuel unit comprises a fixed-bed molecular reconstruction reactor, a recycle separator, a liquid-phase separator, and a fractionation unit; under an action of the hydrogen source from a first hydrogen purification device, the fixed-bed molecular reconstruction reactor performs the hydro-reconstruction reaction on the low-oxygen bio-oil components; hydrogen separated from products by the recycle separator is purified by the first hydrogen purification device, and a separated liquid phase enters the liquid-phase separator for oil-water separation into an oil phase and a water phase; the oil phase enters the fractionation unit to fractionate C₈-C₁₆ hydrocarbon-based biomass aviation fuel and obtain the co-produced distillate; the water phase is the organic solution which is sent to an organic solution reforming hydrogen production reactor; hydrogen produced is purified by a second hydrogen purification device to obtain green hydrogen.

6. An anti-coking and stably operating method for co-producing aviation fuel and chemical feedstock from waste biomass, comprising using the anti-coking and stably operating apparatus for co-producing aviation fuel and chemical feedstock from waste biomass according to claim 1, and performing the following steps:
S1: subjecting the waste biomass to drying and coupled thermal treatment via the second-scale biomass drying-coupled pyrolysis and fractionation conversion to bio-crude unit to obtain a pyrolysis oil-gas and the pyrolysis char, wherein the pyrolysis oil-gas and the pyrolysis char are separated by a cyclone separator; the pyrolysis gas generated by cooling the pyrolysis oil-gas is further subjected to a water-gas shift reaction to prepare green hydrogen as the hydrogen source, with the bio-crude obtained synchronously during the cooling of the pyrolysis oil-gas; and the pyrolysis char is combusted to release heat for supplying energy to biomass drying and coupled thermal treatment;
S2: converting the bio-crude into the low-oxygen bio-oil via the bio-crude suspended bed hydrodeoxygenation and upgrading to low-oxygen bio-oil unit, wherein the bio-crude, the hydrogen donor, and the circulating slurry are premixed, then mixed with the hydrogen source in a pipeline, and subsequently passed through the flash reaction thermal start-up mechanism to be rapidly brought into a reaction state; the bio-crude is subjected to the hydrodeoxygenation and upgrading reaction to obtain the low-oxygen bio-oil; during the reaction, the separated heavy oil is used as the circulating slurry, the separated hydrogen is purified to serve as the hydrogen source, and the separated organic solvent is reformed to prepare green hydrogen as the hydrogen source;
S3: subjecting the low-oxygen bio-oil components to the hydro-reconstruction reaction via the low-oxygen bio-oil fixed-bed molecular reconstruction to hydrocarbon aviation fuel unit to obtain the biomass aviation fuel components, wherein during the reaction, the separated organic solution is reformed to prepare green hydrogen as the hydrogen source, and the co-produced distillate obtained by fractionation is used as the hydrogen donor.

7. The anti-coking and stably operating method for co-producing aviation fuel and chemical feedstock from waste biomass according to claim 6, wherein for the hydrodeoxygenation and upgrading reaction of the bio-crude, a temperature is 200-400° C., a reaction pressure is 8-15 MPa, a volume hourly space velocity is 0.6-2.0 h⁻¹, a hydrogen-oil ratio is 400:1-1500:1, and a residence time is 1-4 h, with an oxygen content of the resulting product being 0.2-1%;
for the hydro-reconstruction reaction of the low-oxygen bio-oil, a temperature is 150-450° C., a reaction pressure is 5-20 MPa, a volume hourly space velocity is 0.25-4.0 h⁻¹, a hydrogen-oil ratio is 400:1-1500:1, and a residence time is 1-4 h; a final boiling point after molecular reconstruction is 200-300° C., a main product is biomass aviation fuel accounting for 50-60% of a total yield of the bio-crude, and the co-produced distillate is bio-naphtha serving as the chemical feedstock.

8. The anti-coking and stably operating apparatus for co-producing aviation fuel and chemical feedstock from waste biomass according to claim 4, wherein the low-oxygen bio-oil fixed-bed molecular reconstruction to hydrocarbon aviation fuel unit comprises a fixed-bed molecular reconstruction reactor, a recycle separator, a liquid-phase separator, and a fractionation unit; under an action of the hydrogen source from the first hydrogen purification device, the fixed-bed molecular reconstruction reactor performs the hydro-reconstruction reaction on the low-oxygen bio-oil components; hydrogen separated from products by the recycle separator is purified by the first hydrogen purification device, and the separated liquid phase enters the liquid-phase separator for oil-water separation into the oil phase and the water phase; the oil phase enters the fractionation unit to fractionate C₈-C₁₆ hydrocarbon-based biomass aviation fuel and obtain the co-produced distillate; the water phase is the organic solution which is sent to the organic solution reforming hydrogen production reactor; the hydrogen produced is purified by the second hydrogen purification device to obtain green hydrogen.

9. The anti-coking and stably operating method for co-producing aviation fuel and chemical feedstock from waste biomass according to claim 6, wherein in anti-coking and stably operating apparatus for co-producing aviation fuel and chemical feedstock from waste biomass, the second-scale biomass drying-coupled pyrolysis and fractionation conversion to bio-crude unit comprises a second-scale dryer, a second-scale pyrolysis reactor, the cyclone separator, a combustion furnace, a cooling tower, and a water-gas shift reactor; the second-scale dryer is connected to the second-scale pyrolysis reactor, and dried biomass is sent to the second-scale pyrolysis reactor for coupled thermal treatment to obtain the pyrolysis oil-gas and the pyrolysis char; the pyrolysis oil-gas and the pyrolysis char are separated by the cyclone separator, the separated pyrolysis char is returned to the combustion furnace to provide heat for the second-scale dryer and/or the second-scale pyrolysis reactor; the pyrolysis gas discharged from the cooling tower after cooling the separated pyrolysis oil-gas enters the water-gas shift reactor, and then green hydrogen is prepared by a first hydrogen purification device connected to the water-gas shift reactor; a cooled pyrolysis oil, i.e., the bio-crude, is collected by a bio-crude collection device.

10. The anti-coking and stably operating method for co-producing aviation fuel and chemical feedstock from waste biomass according to claim 6, wherein in anti-coking and stably operating apparatus for co-producing aviation fuel and chemical feedstock from waste biomass, the bio-crude mixing tank is further added with a catalyst for the hydrodeoxygenation and upgrading reaction; a catalyst dosage is controlled by adjusting a circulation state of the catalyst in an operating zone of the suspended bed hydrodeoxygenation and upgrading reactor; coarse catalysts participate in an internal circulation of the reactor, fine catalysts participate in an external circulation of the reactor, and powdered catalysts are separated and discharged; discharged catalysts are supplemented through the bio-crude mixing tank; a particle size of the coarse catalysts is 70-100% of an initial catalyst particle size; a particle size of the fine catalysts is 30-70% of the initial catalyst particle size excluding both endpoints; a particle size of the powdered catalysts is 0-30% of the initial catalyst particle size excluding endpoint 0.

11. The anti-coking and stably operating method for co-producing aviation fuel and chemical feedstock from waste biomass according to claim 6, wherein in anti-coking and stably operating apparatus for co-producing aviation fuel and chemical feedstock from waste biomass, the separator assembly in the bio-crude suspended bed hydrodeoxygenation and upgrading to low-oxygen bio-oil unit comprises a hot high-pressure separator, a cold high-pressure separator, a flash tank, and a cold low-pressure separator; the products from the hydrodeoxygenation and upgrading reaction are first subjected to gas-liquid separation by the hot high-pressure separator; a separated gas phase is further separated to obtain hydrogen by the cold high-pressure separator, and the hydrogen is purified by a first hydrogen purification device to serve as the hydrogen source; based on a difference in boiling points, a separated liquid phase is separated into a light oil and the heavy oil by the flash tank, and the heavy oil is delivered to the bio-crude mixing tank as the circulating slurry; the light oil obtained by flash evaporation in the flash tank is mixed with a liquid phase separated by the cold high-pressure separator, and then subjected to oil-water separation into an oil phase and a water phase by the cold low-pressure separator; the obtained oil phase is the low-oxygen bio-oil, and the obtained water phase is the organic solution which is sent to an organic solution reforming hydrogen production reactor; hydrogen produced is purified by a second hydrogen purification device to obtain green hydrogen.

12. The anti-coking and stably operating method for co-producing aviation fuel and chemical feedstock from waste biomass according to claim 6, wherein in anti-coking and stably operating apparatus for co-producing aviation fuel and chemical feedstock from waste biomass, the low-oxygen bio-oil fixed-bed molecular reconstruction to hydrocarbon aviation fuel unit comprises a fixed-bed molecular reconstruction reactor, a recycle separator, a liquid-phase separator, and a fractionation unit; under an action of the hydrogen source from a first hydrogen purification device, the fixed-bed molecular reconstruction reactor performs the hydro-reconstruction reaction on the low-oxygen bio-oil components; hydrogen separated from products by the recycle separator is purified by the first hydrogen purification device, and a separated liquid phase enters the liquid-phase separator for oil-water separation into an oil phase and a water phase; the oil phase enters the fractionation unit to fractionate C₈-C₁₆ hydrocarbon-based biomass aviation fuel and obtain the co-produced distillate; the water phase is the organic solution which is sent to an organic solution reforming hydrogen production reactor; hydrogen produced is purified by a second hydrogen purification device to obtain green hydrogen.

13. The anti-coking and stably operating method for co-producing aviation fuel and chemical feedstock from waste biomass according to claim 11, wherein in anti-coking and stably operating apparatus for co-producing aviation fuel and chemical feedstock from waste biomass, the low-oxygen bio-oil fixed-bed molecular reconstruction to hydrocarbon aviation fuel unit comprises a fixed-bed molecular reconstruction reactor, a recycle separator, a liquid-phase separator, and a fractionation unit; under an action of the hydrogen source from the first hydrogen purification device, the fixed-bed molecular reconstruction reactor performs the hydro-reconstruction reaction on the low-oxygen bio-oil components; hydrogen separated from products by the recycle separator is purified by the first hydrogen purification device, and the separated liquid phase enters the liquid-phase separator for oil-water separation into the oil phase and the water phase; the oil phase enters the fractionation unit to fractionate C₈-C₁₆ hydrocarbon-based biomass aviation fuel and obtain the co-produced distillate; the water phase is the organic solution which is sent to the organic solution reforming hydrogen production reactor; the hydrogen produced is purified by the second hydrogen purification device to obtain green hydrogen.

14. The anti-coking and stably operating method for co-producing aviation fuel and chemical feedstock from waste biomass according to claim 9, wherein for the hydrodeoxygenation and upgrading reaction of the bio-crude, a temperature is 200-400° C., a reaction pressure is 8-15 MPa, a volume hourly space velocity is 0.6-2.0 h⁻¹, a hydrogen-oil ratio is 400:1-1500:1, and a residence time is 1-4 h, with an oxygen content of the resulting product being 0.2-1%;
for the hydro-reconstruction reaction of the low-oxygen bio-oil, a temperature is 150-450° C., a reaction pressure is 5-20 MPa, a volume hourly space velocity is 0.25-4.0 h⁻¹, a hydrogen-oil ratio is 400:1-1500:1, and a residence time is 1-4 h; a final boiling point after molecular reconstruction is 200-300° C., a main product is biomass aviation fuel accounting for 50-60% of a total yield of the bio-crude, and the co-produced distillate is bio-naphtha serving as the chemical feedstock.

15. The anti-coking and stably operating method for co-producing aviation fuel and chemical feedstock from waste biomass according to claim 10, wherein for the hydrodeoxygenation and upgrading reaction of the bio-crude, a temperature is 200-400° C., a reaction pressure is 8-15 MPa, a volume hourly space velocity is 0.6-2.0 h⁻¹, a hydrogen-oil ratio is 400:1-1500:1, and a residence time is 1-4 h, with an oxygen content of the resulting product being 0.2-1%;
for the hydro-reconstruction reaction of the low-oxygen bio-oil, a temperature is 150-450° C., a reaction pressure is 5-20 MPa, a volume hourly space velocity is 0.25-4.0 h⁻¹, a hydrogen-oil ratio is 400:1-1500:1, and a residence time is 1-4 h; a final boiling point after molecular reconstruction is 200-300° C., a main product is biomass aviation fuel accounting for 50-60% of a total yield of the bio-crude, and the co-produced distillate is bio-naphtha serving as the chemical feedstock.

16. The anti-coking and stably operating method for co-producing aviation fuel and chemical feedstock from waste biomass according to claim 11, wherein for the hydrodeoxygenation and upgrading reaction of the bio-crude, a temperature is 200-400° C., a reaction pressure is 8-15 MPa, a volume hourly space velocity is 0.6-2.0 h⁻¹, a hydrogen-oil ratio is 400:1-1500:1, and a residence time is 1-4 h, with an oxygen content of the resulting product being 0.2-1%;
for the hydro-reconstruction reaction of the low-oxygen bio-oil, a temperature is 150-450° C., a reaction pressure is 5-20 MPa, a volume hourly space velocity is 0.25-4.0 h⁻¹, a hydrogen-oil ratio is 400:1-1500:1, and a residence time is 1-4 h; a final boiling point after molecular reconstruction is 200-300° C., a main product is biomass aviation fuel accounting for 50-60% of a total yield of the bio-crude, and the co-produced distillate is bio-naphtha serving as the chemical feedstock.

17. The anti-coking and stably operating method for co-producing aviation fuel and chemical feedstock from waste biomass according to claim 12, wherein for the hydrodeoxygenation and upgrading reaction of the bio-crude, a temperature is 200-400° C., a reaction pressure is 8-15 MPa, a volume hourly space velocity is 0.6-2.0 h⁻¹, a hydrogen-oil ratio is 400:1-1500:1, and a residence time is 1-4 h, with an oxygen content of the resulting product being 0.2-1%;
for the hydro-reconstruction reaction of the low-oxygen bio-oil, a temperature is 150-450° C., a reaction pressure is 5-20 MPa, a volume hourly space velocity is 0.25-4.0 h⁻¹, a hydrogen-oil ratio is 400:1-1500:1, and a residence time is 1-4 h; a final boiling point after molecular reconstruction is 200-300° C., a main product is biomass aviation fuel accounting for 50-60% of a total yield of the bio-crude, and the co-produced distillate is bio-naphtha serving as the chemical feedstock.

18. The anti-coking and stably operating method for co-producing aviation fuel and chemical feedstock from waste biomass according to claim 13, wherein for the hydrodeoxygenation and upgrading reaction of the bio-crude, a temperature is 200-400° C., a reaction pressure is 8-15 MPa, a volume hourly space velocity is 0.6-2.0 h⁻¹, a hydrogen-oil ratio is 400:1-1500:1, and a residence time is 1-4 h, with an oxygen content of the resulting product being 0.2-1%;
for the hydro-reconstruction reaction of the low-oxygen bio-oil, a temperature is 150-450° C., a reaction pressure is 5-20 MPa, a volume hourly space velocity is 0.25-4.0 h⁻¹, a hydrogen-oil ratio is 400:1-1500:1, and a residence time is 1-4 h; a final boiling point after molecular reconstruction is 200-300° C., a main product is biomass aviation fuel accounting for 50-60% of a total yield of the bio-crude, and the co-produced distillate is bio-naphtha serving as the chemical feedstock.
